(19) United States
(12) Patent Application Publication
(10) Pub. No.: US 2015/0282193 A1
(43) Pub. Date: Oct. 1, 2015

(54) METHOD AND APPARATUS FOR AVOIDING COMMUNICATION INTERFERENCE IN WIRELESS COMMUNICATION SYSTEM

(71) Applicant: Electronics and Telecommunications Research Institute, Daejeon (KR)

(72) Inventors: Hong Soog KIM, Daejeon (KR); Joon Soo LEE, Daejeon (KR); Je Hun LEE, Daejeon (KR); Sok Kyu LEE, Daejeon (KR)

(21) Appl. No.: 14/671,433

(22) Filed: Mar. 27, 2015

(30) Foreign Application Priority Data
Mar. 27, 2014 (KR) 10-2014-0036068

(51) Int. Cl. H04W 72/08; H04W 72/04; H04W 4/00

(52) U.S. Cl. CPC H04W 72/082; H04W 4/008; H04W 72/048; H04W 84/12

(57) ABSTRACT

Provided is a communication control apparatus for controlling data transmission performed by a first communication module and a second communication module, each using a different communication scheme, the apparatus including a storing unit to store, in a data structure, channel information on a communication module for avoiding communication interference between the first communication module and the second communication module, and a processor to set, based on the channel information, a channel different from a channel used by the first communication module as a channel of the second communication module, wherein the first communication module and the second communication module are included in an identical device.

### CROSS-REFERENCE TO RELATED APPLICATION

This application claims the priority benefit of Korean Patent Application No. 10-2014-0036068, filed on Mar. 27, 2014, in the Korean Intellectual Property Office, the disclosure of which is incorporated herein by reference.

### BACKGROUND

1. Field of the Invention

Embodiments of the present invention relate to a method and apparatus for avoiding communication interference in a wireless communication system, and more particularly, to a method and apparatus for avoiding communication interference when a wireless local area network (WLAN) module and a Bluetooth module are mounted.

2. Description of the Related Art

Communication interference may occur between a Bluetooth device and an Institute of Electrical and Electronics Engineers (IEEE) 802.11-based wireless local area network (WLAN) device when the Bluetooth device performs communication in a 2.4 gigahertz (GHz) band and the IEEE 802.11-based WLAN device performs communication in the 2.4 GHz band.

In an IEEE 802.11 standard, a channel may be defined in the 2.4 GHz band, and a size of each channel may be 20 megahertz (MHz). In an IEEE 802.11n standard, a 40 MHz channel may be available using one primary channel and one neighboring extension channel.

In a Bluetooth standard, 79 channels for communicating in the 2.4 GHz band may be defined. Each of the channels may be segmented based on a unit of 1 MHz. A frequency band from 2.402 GHz to 2.480 GHz may be available. A signal transmitted in the Bluetooth device may be spread to the 2.4 GHz band, and 1600 times of frequency hopping per second may be allowed to avoid interference with another wireless communication device. A signal received by a predetermined Bluetooth device may be spread to a wideband frequency transmitted from another system using a portion of an identical frequency range. Thus, the signal may affect, as noise, a portion of a frequency range of another Bluetooth device using the frequency hopping. However, the signal may affect a signal of another device using the 2.4 GHz band as interference.

When an industrial scientific medical (ISM) band is used, a bandwidth of one channel in the IEEE 802.11 may correspond to bandwidths of 20 Bluetooth channels. Thus, when a frequency channel using the frequency hopping adopted for communication of the Bluetooth device and an IEEE 802.11-based WLAN communication device using a channel including a corresponding Bluetooth channel are provided, and when a separate method of adjusting a channel use between the Bluetooth device and the IEEE 802.11-based WLAN communication device is not employed, mutual interference may occur between the two devices.

When the Bluetooth device performs the frequency hopping 1600 times per second, each of 79 Bluetooth channels may be reused up to 20 times per second (1600/79=20.253) and thus, the mutual interference may occur with frequency.

Accordingly, to minimize interference in a case in which a Bluetooth device and a WLAN device coexist, channel use information may need to be exchanged between the Bluetooth device and the WLAN device. Through this, the Bluetooth device and the WLAN device may prevent channels from overlapping so as to avoid interference that may occur between the Bluetooth device and the WLAN device.

### SUMMARY

According to an aspect of the present invention, there is provided a communication control apparatus for controlling data transmission performed by a first communication module and a second communication module, each using a different communication scheme, the apparatus including a storing unit to store, in a data structure, channel information on a communication module for avoiding communication interference between the first communication module and the second communication module, and a processor to set, based on the channel information, a channel different from a channel used by the first communication module as a channel of the second communication module, wherein the first communication module and the second communication module are included in an identical device.

The channel information may include at least one of information indicating whether each of the first communication module and the second communication module is using a channel, and information indicating a frequency band used by each of the first communication module and the second communication module.

When the first communication module fails to receive updated channel information on the second communication module from the second communication module within a predetermined period of time, the processor may determine that channel information on the second communication module stored in the data structure is invalid.

According to another aspect of the present invention, there is also provided a communication control apparatus for controlling data transmission performed by a first communication module and a second communication module, each using a different communication scheme, the apparatus including a detector to detect a change in a parameter related to a field configuring a data structure for avoiding communication interference (DSACI) between the first communication module and the second communication module, or a change in a communication state of each of the first communication module and the second communication module, and a processor to set a channel in which each of the first communication module and the second communication module avoids communication interference by analyzing the change in the parameter or the change in the communication state, wherein the first communication module and the second communication module are included in an identical device.

The communication state may correspond to at least one of primary initiation of the first communication module and the second communication, initiation due to the first communication module and the second communication module being reset, and a change in a frequency band used by each of the first communication module and the second communication module.

The field configuring the DSACI may include at least one of a field indicating whether each of the first communication module and the second communication module is using a channel, and a field indicating a frequency band used by each of the first communication module and the second communication module.

The communication control apparatus may further include a communicator to transfer a message including the change in the parameter or the change in the communication state, to the DSACI.

When the message includes the change in the parameter or the change in the communication state of the first communication module, the communicator may transfer the message to the second communication module, and when the message includes the change in the parameter or the change in the communication state of the second communication module, the communicator may transfer the message to the first communication module.

When the first communication module primarily initiates communication, or when the first communication module initiates the communication due to a reset, the communicator may request information on a DSACI of the second communication module from the second communication module.

The processor may include a first processor to set a channel for the first communication module from among channels different from a channel used by the second communication module, and a second processor to set a channel for the second communication module from among channels different from a channel used by the first communication module.

The communicator may transfer information on the communication state or information on the parameter of the first communication module to the second communication module in a first cycle, and transfer information on the communication state or information on the parameter of the second communication module to the first communication module in a second cycle.

When the first communication module fails to receive the information on the communication state or the information on the parameter of the second communication module in the second cycle, the processor may determine that a field of the DSACI relating to the second communication module is invalid.

The first communication module may be a Bluetooth module and the second communication module may be a WLAN module.

According to still another aspect of the present invention, there is also provided a communication control method for controlling data transmission performed by a first communication module and a second communication module, each using a different communication scheme, the method including storing channel information on a communication module for avoiding communication interference between the first communication module and the second communication module, and setting, based on the channel information, a channel different from a channel used by the first communication module as a channel of the second communication module, wherein the first communication module and the second communication module are included in an identical device.

The communication control method may further include determining that channel information on the second communication module stored in the data structure is invalid when the first communication module fails to receive updated channel information on the second communication module from the second communication module within a predetermined period of time.

According to yet another aspect of the present invention, there is also provided a communication control method of controlling data transmission performed by a first communication module and a second communication module, each using a different communication scheme, the method including detecting a change in a parameter related to a field configuring a DSACI between the first communication module and the second communication module, or a change in a communication state of each of the first communication module and the second communication module, and setting a channel in which each of the first communication module and the second communication module avoids the communication interference by analyzing the detected change in the parameter or the detected change in the communication state, wherein the first communication module and the second communication module are included in an identical device.

The field configuring the DSACI may include at least one of a field indicating whether each of the first communication module and the second communication module is using a channel, and a field indicating a frequency band used by each of the first communication module and the second communication module.

The setting may include setting a channel for the first communication module from among channels different from a channel used by the second communication module, and setting a channel for the second communication module from among channels different from a channel used by the first communication module.

The communication control method may further include transferring information on the communication state or information on the parameter of the first communication module to the second communication module in a first cycle, and transferring information on the communication state or information on the parameter of the second communication module to the first communication module in a second cycle.

When the first communication module fails to receive the information on the communication state or the information on the parameter of the second communication module in the second cycle, a field of a DSACI relating to the second communication module may be determined to be invalid.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a communication system including a Bluetooth module and a wireless local area network (WLAN) module according to an example embodiment;

FIG. 2 is a block diagram illustrating an example of a communication control apparatus according to an example embodiment;

FIG. 3 is a flowchart illustrating an example of a communication control method according to an example embodiment;

FIG. 4 is a block diagram illustrating another example of a communication control apparatus according to an example embodiment;

FIG. 5 is a block diagram illustrating still another example of a communication control apparatus according to an example embodiment;

FIG. 6 is a flowchart illustrating another example of a communication control method according to an example embodiment;

FIG. 7 is a flowchart illustrating an operation performed by a communication control apparatus when a change in a communication state related to a first communication module is detected according to an example embodiment;

FIG. 8 is a flowchart illustrating an operation performed by a communication control apparatus when a communication state or a parameter related to a first communication module is changed according to an example embodiment;

FIG. 9 is a flowchart illustrating an operation performed by a communication control apparatus in response to receiving information on a changed data structure for avoiding communication interference (DSACI) of a counterpart communication module according to an example embodiment;

FIG. 10 is a flowchart illustrating an example of transmitting an operation state message of a first communication module to a second communication module at each first cycle according to an example embodiment;

FIG. 11 is a flowchart illustrating an operation performed by a communication control apparatus when an operation state message of a second communication module is received within a second cycle according to an example embodiment; and

FIG. 12 is a flowchart illustrating an operation performed by a communication control apparatus when an operation state message of a second communication module is not received within a second cycle according to an example embodiment.

### DETAILED DESCRIPTION

Hereinafter, exemplary embodiments will be described in detail with reference to the accompanying drawings.

The terms used in this specification were selected to include current, widely-used, general terms, in consideration of the functions of the present invention. However, the terms may represent different meanings according to the intentions of the skilled person in the art or according to customary usage, the appearance of new technology, etc.

In certain cases, a term may be one that was arbitrarily established by the applicant. In such cases, the meaning of the term will be defined in the relevant portion of the detailed description. As such, the terms used in the specification are not to be defined simply by the name of the terms but are to be defined based on the meanings of the terms as well as the overall description of the present invention.

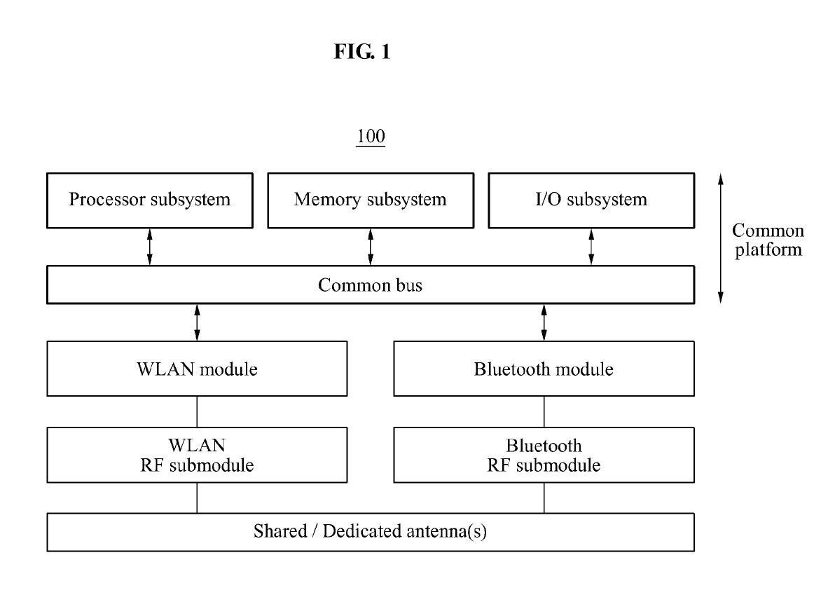

FIG. 1 is a block diagram illustrating a configuration of a communication system including a Bluetooth module and a wireless local area network (WLAN) module according to an example embodiment.

Referring to FIG. 1, a wireless communication system 100 includes the Bluetooth module and the WLAN module. In the wireless communication system 100, a module in which a WLAN communication function is implemented and a module in which a Bluetooth function is implemented may be included on a common platform to which a processor, a memory subsystem, an input/output (I/O) subsystem are connected through a common bus. Hereinafter, the module in which a WLAN communication function is implemented may also be referred to as the WLAN module, and the module in which a Bluetooth function is implemented may also be referred to as the Bluetooth module.

In this example, the WLAN module and the Bluetooth module may be configured in separate modules, and may also be configured in a single module. Thus, a case in which the WLAN module and the Bluetooth module are configured in separate modules and a case in which the WLAN module and the Bluetooth module are physically configured in a single module may be included within the scope of the present disclosure.

The process subsystem may include a single core or a multi-core. The memory subsystem may provide a memory required for the processor subsystem, and may be connected to a memory in a communication module through the common bus. The I/O subsystem may provide a function required for input and output of communication modules and input and output performed via the common platform.

The communication module may include a firmware, a memory, and hardware logic. In the firmware, functions to be implemented though software among functions corresponding to a layer such as logic of a communication standard may be provided in a form of a thread or a process on the firmware. The firmware may communicate with a firmware included in another module using the common bus. Also, the firmware may be connected to lower hardware logic and a memory of a module using an interface therebetween.

The memory may be connected to the lower hardware logic, the firmware, and the common bus using a common interface. The memory may maintain and manage data required for the lower hardware logic, and copy the data to the memory subsystem connected using the common bus. The memory subsystem may also copy required data to the memory for each module.

The hardware logic may implement a function corresponding to a first layer and a portion requiring a hardware process among logics corresponding to a second layer of each communication standard. The hardware logic may have a connection interface among a lower submodule, a memory, and an upper firmware.

Hereinafter, a communication control apparatus and a communication control method will be explained with reference to the following descriptions.

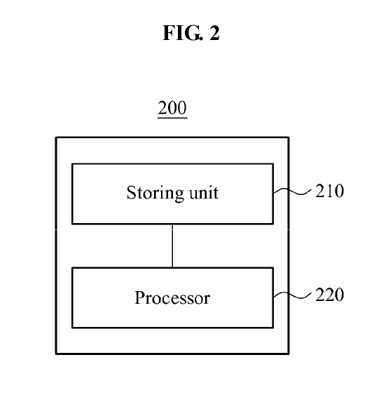

FIG. 2 is a block diagram illustrating a communication control apparatus 200 according to an example embodiment.

Referring to FIG. 2, the communication control apparatus 200 includes a storing unit 210 and a processor 220. The storing unit 210 may store, in a data structure, channel information on a communication module for avoiding communication interference between a first communication module and a second communication module. In this example, the first communication module and the second communication module may use a different communication scheme from one another. The processor 220 may set a channel different from a channel used by the first communication module as a channel of the second communication module.

The first communication module may be a Bluetooth module, and the second communication module may be a WLAN module. The Bluetooth module and the WLAN module may be included in an identical device.

In an example, the communication control apparatus 200 may be configured separately from a device including the WLAN module and the Bluetooth module. Also, the communication control apparatus 200 and the device may be configured in a single module. Thus, a case in which the communication control apparatus 200 is configured separate from the device and a case in which the communication control apparatus 200 and the device are physically configured in a single module may be included within the scope of the present disclosure.

In an example embodiment, the channel information may include information indicating whether each of the first communication module and the second communication module is using a channel. Although each the first communication module and the second communication module communicates using a different scheme, in a process of communicating, frequency bands used by the first communication module and the second communication module may overlap. Concisely, frequency bands may overlap in a process of communication between the first communication module and the second communication module. Thus, when the first communication is not performing communication, the second communication module may perform communication using a frequency band overlapping that of the first communication module.

In another example embodiment, the channel information may include information indicating a frequency band used by each of the first communication module and the second communication module. When the first communication module is performing communication, and when the second communication module uses the frequency band being used by the first communication module, interference may occur between the first communication module and the second communication module. Thus, the second communication module may use a communication module being unused by the first communication module to minimize the interference.

When updated channel information on the second communication module is not received by the first communication module within a predetermined period of time, the processor 220 may determine that channel information on the second communication module stored in the data structure is invalid.

When updated channel information on the first communication module is not received by the second communication module within a predetermined period of time, the processor 220 may determine that channel information on the first communication module stored in the data structure is invalid.

When the first communication module performs the communication without receiving the updated channel information on the second communication module in the predetermine period of time, the first communication module may use the frequency band being used by the second communication module, and then the interference may occur between the first communication module and the second communication module. Thus, when updated channel information on a counterpart communication module is not received within a predetermined period of time, the processor 220 may determine that channel information stored in the data structure is invalid. By not using a frequency band being used by the counterpart communication module, interference between communication modules may be minimized.

Hereinafter, descriptions about various operations or applications performed by the communication control apparatus will be provided. Although one element, for example, a storing unit and a processor is not specified, contents of an extent that can be expected and understood clearly by those skilled in the art to which the present disclosure pertains may be understood as an ordinary implementation and thus, the scope of the present invention is not intended to be limited by the terms or physical/logical structures of the specific configurations.

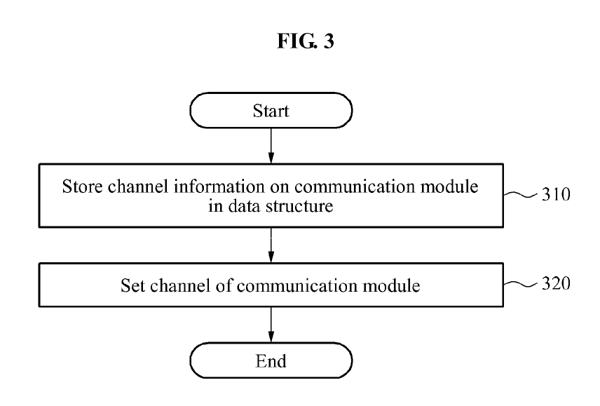

FIG. 3 is a flowchart illustrating an example of a communication control method according to an example embodiment.

In operation 310, a storing unit stores channel information on a communication module for avoiding communication interference between a first communication module and a second communication module in a data structure. In this example, the channel information may include at least one of information indicating whether each of the first communication module and the second communication module is using a channel, and information indicating a frequency band used by each of the first communication module and the second communication module.

Each of the first communication module and the second communication module may transmit data using a different communication scheme, and may be included in an identical device.

In operation 320, the processor sets a channel different from a channel used by the first communication module as a channel of the second communication module based on the channel information. Also, the processor sets a channel different from a channel used by the second communication module as a channel of the first communication module based on the channel information. Thus, in response to receiving information on a channel being used currently, interference due to using an overlapping frequency band may be efficiently avoided between the first communication module and the second communication module.

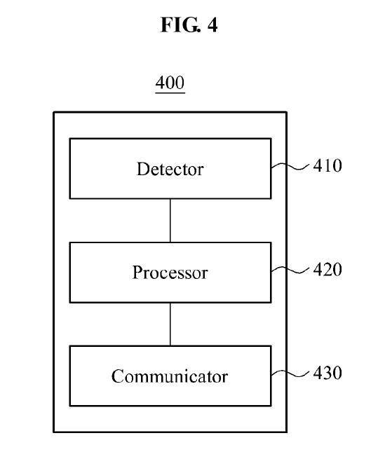

FIG. 4 is a block diagram illustrating a configuration of a communication control apparatus 400 according to an example embodiment.

Referring to FIG. 4, the communication control apparatus 400 includes a detector 410 and a processor 420. The detector 410 may detect a change in a parameter related to a field configuring a data structure for avoiding communication interference (DSACI) between a first communication module and a second communication module. Hereinafter, the data structure for avoiding communication interference between the first communication module and the second communication module may also be referred to as the DSACI. In this example, each of the first communication module and the second communication module may perform communication using a different scheme, and may be included in an identical device.

In an example embodiment, the first communication module may be a Bluetooth module and the second communication module may be a WLAN module.

The detector 410 may detect a change in a communication state for each of the first communication module and the second communication module. As an example, the communication state may include a primary initiation state for each of the first communication module and the second communication module. For example, the communication state may include a state in which the first communication module or the second communication module is initially activated in a device including the first communication module and the second communication module.

As another example, the communication state may include a change in a frequency band used by a communication module or initiation due to a reset of the communication module. The change in the frequency band of the communication module may indicate a change in a frequency band used by each of the first communication module and/or the second communication module.

The processor 420 may set a channel in which each of the first communication module and the second communication module avoids communication interference by analyzing the detected change in the parameter or the detected change in the communication state.

The processor 420 may include a first processor to set a channel for the first communication module among channels different from a channel used by the second communication module. Also, the processor 420 may include a second processor to set a channel for the second communication module among channels different from a channel used by the first communication module.

In an example embodiment, the field configuring the DSACI may include a field indicating whether a channel is used by the first communication module and/or the second communication module. The parameter may indicate information on the field configuring the DSACI.

For example, a WLAN On/Off field may indicate whether a WLAN communication module is being used. The WLAN On/Off may be updated for each time in which a use state of the WLAN communication module by the processor 420 implemented on a firmware in the WLAN communication module. When the WLAN communication module is being unused, the Bluetooth module may be free from interference due to the WLAN module present in company with the Bluetooth module.

In another example embodiment, the field configuring the DSACI may include a field indicating the frequency band used by each of the first communication module and/or the second communication module.

In an example, a WLAN Freq. field may be valid only when a value of the WLAN On/Off field is “on”, and may indicate a band being used by the WLAN communication module. A 5 gigahertz (GHz) band may be used in the Institute of Electrical and Electronics Engineers (IEEE) 802.11a, a 2.4 GHz band may be used in the IEEE 802.11b/g/n, and the 5 GHz band may be used in the IEEE 802.11n/ac. Thus, IEEE 802.11b/g/n-based WLAN module communication may cause interference in a Bluetooth module communication.

In another example, a WLAN WideBand On/Off field may be valid only when the value of the WLAN On/Off field is “on” and a value of the WLAN Freq. field indicates 2.4 GHz. In the IEEE 802.11n, two 20 megahertz (MHz) bands of may be used depending on a case and thus, a field for distinguishing the case may be provided.

In still another example, a WLAN Ch. No field may be valid only when the value of the WLAN on/off field is “on”, and may maintain information on a channel number used in the 2.4 GHz band through a WLAN. The Bluetooth module may acquire an overall channel range for use in the WLAN module based on the value of the WLAN Ch. No field and the value of the WLAN WideBand On/Off field. Frequency hopping may be applied within an unused WLAN channel range.

In yet another example, a BT On/Off field may indicate whether the Bluetooth module is being used. The BT On/Off field may be updated each time the use state of the Bluetooth communication module is changed by the processor 420 implemented on the firmware in the Bluetooth communication module.

In further another example, a BT SCO On/Off field may indicate whether the Bluetooth module is performing a synchronous connection-oriented (SCO) communication. When a value of the BT SCO On/Off field is “on”, the WLAN communication module may not change a channel being used by the WLAN communication module. Similar to an audio or voice communication, an SCO data communication may be susceptible to a delay and thus, need to be protected therefrom.

Various alterations and modifications may be made to the above example embodiments, some of which are illustrated in detailed description. However, it should be understood that these example embodiments are not construed as limited to the illustrated forms.

The communication control apparatus 400 also includes a communicator 430. The communicator 430 may transfer a message including the detected change in the parameter or the detected change in the communication state to the DSACI.

The communicator 430 may transfer a message including information on the change in the parameter and/or the change in the communication state of the first communication module to the second communication module. Also, the communicator 430 may transfer a message including information on the change in the parameter and/or the change in the communication state of the second communication module to the first communication module.

When the first communication module primarily initiates the communication, or when the first communication module initiates the communication due to a reset, the communicator 430 may request information on a DSACI of the second communication module from the second communication module.

When the second communication module primarily initiates the communication, or when the second communication module initiates the communication due to a reset, the communicator 430 may request information on a DSACI of the first communication module from the first communication module.

The communicator 430 may transfer information on the parameter or the communication state of the first communication module to the second communication module in a first cycle. Also, the communicator 430 may transfer information on the parameter or the communication state of the second communication module to the first communication module in a second cycle.

When the first communication module fails to receive the information on the parameter or the communication state of the second communication module within the second cycle, the processor 420 may determine that the field of the DSACI relating to the second communication module is invalid.

When the second communication module fails to receive the information on the parameter or the communication state of the first communication module within the first cycle, the processor 420 may determine that the field of the DSACI relating to the first communication module is invalid.

In an example embodiment, in response to receiving information on the channel used by each of the first communication module and the second communication module, the communication control apparatus 400 may set a channel for each of the communication module and the second communication module without overlapping, thereby avoiding interference due to a use of a frequency.

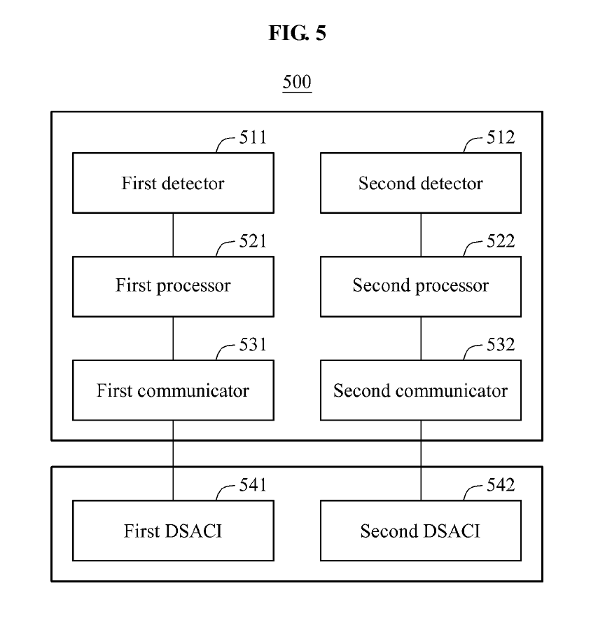

FIG. 5 is a block diagram illustrating a configuration of a communication control apparatus 500 according to an example embodiment.

The communication control apparatus 500 includes a detector, a processor, and a communicator. The detector includes a first detector 511 to detect a change in a parameter related to a first communication module or a change in a communication state of the first communication module. Also, the detector includes a second detector 512 to detect a change in a parameter related to a second communication module or a change in a communication state of the second communication module. The processor includes a first processor 521 and a second processor 522, and the communicator includes a first communicator 531 and a second communicator 532.

In an example embodiment, the first communication module may include a DSACI between the first communication module and the second communication module. In this example, the DSACI included in the first communication module may also be referred to as a first DSACI 541.

In another example embodiment, the second communication module may include a DSACI between the first communication module and the second communication module. In this example, the DSACI included in the second communication module may also be referred to as a second DSACI 542.

Hereinafter, descriptions about various operations or applications performed by the communication control apparatus will be provided. Although one element, for example, a detector, a processor, and a communicator is not specified, contents of an extent that can be expected and understood clearly by those skilled in the art to which the present disclosure pertains may be understood as an ordinary implementation and thus, the scope of the present invention is not intended to be limited by the terms or physical/logical structures of the specific configurations.

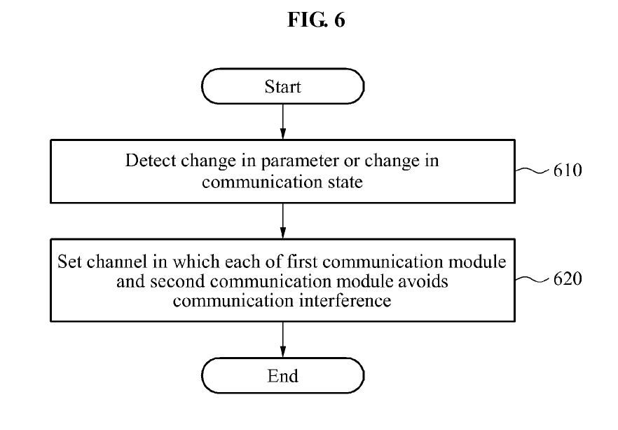

FIG. 6 is a flowchart illustrating another example of a communication control method according to an example embodiment.

In operation 610, a detector detects a change in a parameter related to a field configuring a data structure or a change in a communication state of a communication module. In this example, the data structure may be a DSACI between a first communication module and a second communication module. The first communication module may transmit data using a communication scheme different from that of the second communication module.

The field configuring the DSACI may include at least one of a field indicating whether a channel is used by each of the first communication module and the second communication module and a field indicating a frequency band used by each of the first communication module and the second communication module. Also, the parameter may indicate information on the field configuring the DSACI.

In operation 620, the processor sets a channel in which each of the first communication module and the second communication module avoids communication interference by analyzing the detected change in the parameter or the change in the communication state.

The processor may set a channel for the first communication module among channels different from a channel used by the second communication module. Also, the processor may set a channel for the second communication module among channels different from a channel used by the first communication module.

Although not shown in FIG. 6, the communicator may transfer a message including the detected change in the parameter or the detected change in the communication state to the DSACI. Subsequent to the detecting of the change in the parameter or the change in the communication state, the detector may update a related field in the DSACI of a corresponding communication module. The communicator may transfer a message including the detected change in the parameter or the communication state to a counterpart communication module. The counterpart communication module may update the change included in the message to the related field of the DSACI.

For example, the first detector may detect the change in the communication state or the change in the parameter related to the first communication module. The first processor may update the change in the parameter or the communication state in a related field of a first DSACI. In this example, the first DSACI may be a data structure for avoiding communication interference between the first communication module and the second communication module. The first communicator may transfer the change in the parameter or the communication state to the second communication module. The second processor may update the change in the parameter or the communication state in a related field of a second DSACI. In this example, the second DSACI may be a data structure for avoiding communication interference between the first communication module and the second communication module. The second processor may set a channel of the second communication module based on the second DSACI.

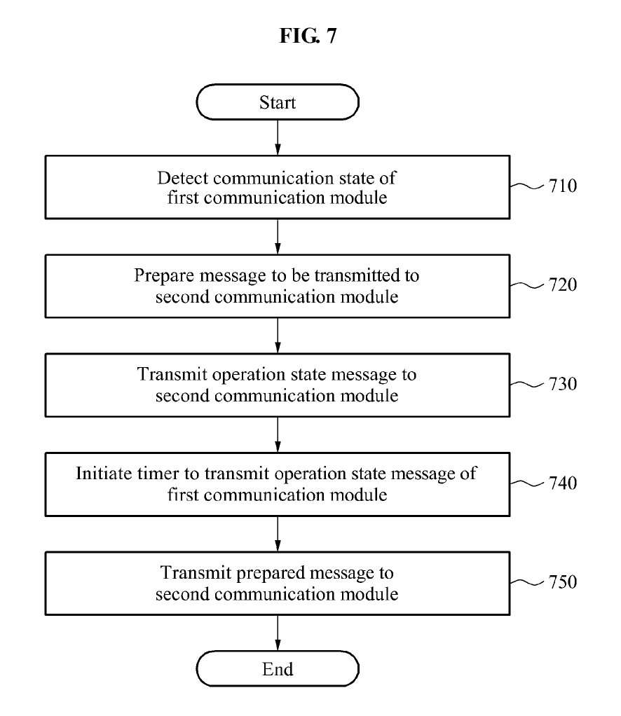

FIG. 7 is a flowchart illustrating an operation performed by a communication control apparatus when a change in a communication state related to a first communication module is detected according to an example embodiment.

In operation 710, a detector detects the communication state of the first communication module. The communication state may include a state in which the first communication module is primarily initiated or activated or a state in which the first communication module is initiated due to a reset.

In operation 720, a processor prepares a message to be transmitted to the second communication module. The message may include information on the communication state of the first communication module. For example, the information may include information on a primary initiation or a reset of the first communication module.

In operation 730, a communicator transmits an operation state message of the first communication module to the second communication module. The operation state message may include a message indicating an operation state of the first processor. The first processor may set a channel of the first communication module based on a first DSACI.

In operation 740, the processor initiates a timer to transmit the operation state message of the first communication module on a period-by-period basis. By periodically transmitting the operation state message, a field relating to the first communication module in the DSACI of the second communication module may be determined to be valid. The processor may set a channel such that communication interference does not occur between the first communication module and the second communication module.

In operation 750, the communicator transmits the message prepared in operation 720 to the second communication module. In response to receiving of information on the first communication module, the second communication module may update the field relating the first communication module in a second DSACI.

In an example embodiment, when a change in a communication state of the second communication module is detected, the communication control apparatus may operate as described in the above example in which the change in the communication state of the first communication module is detected.

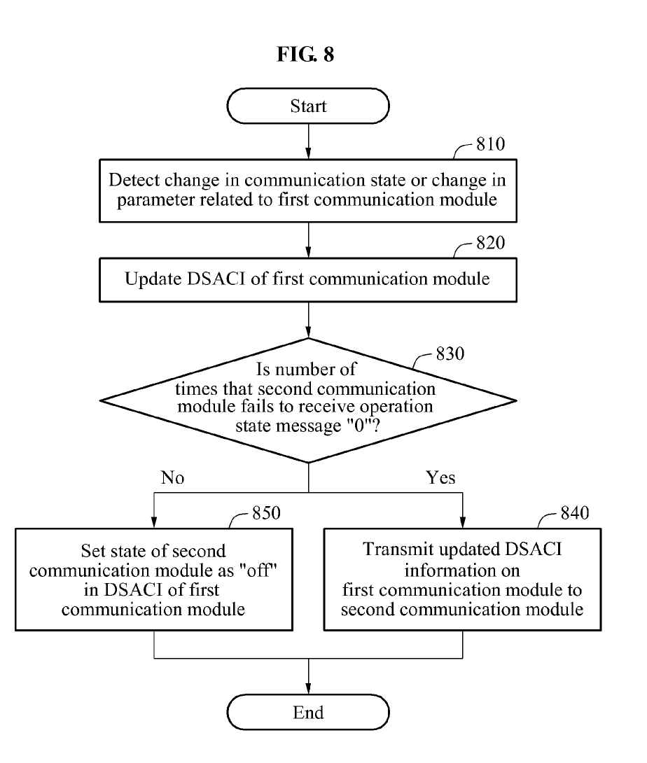

FIG. 8 is a flowchart illustrating an operation performed by a communication control apparatus when a communication state or a parameter related to a first communication module is changed according to an example embodiment.

In operation 810, a detector detects a change in the communication state or a change in the parameter related to the first communication module.

In operation 820, a processor updates a first DSACI with information on the detected change.

In operation 830, the processor determines whether a number of times that the second communication module fails to receive the operation state message is “0”. Depending on a result of the determining, the processor may determine whether updated DSACI information on the first communication module is to be transmitted to the second communication module.

When the number of times is “0”, in operation 840, the processor determines that the updated DSACI information on the first communication module is to be transmitted to the second communication module. A communicator may transmit the updated DSACI information on the first communication module to the second communication module.

When the number of times is not “0”, in operation 850, the processor sets a state of the second communication module to be “off” in the DSACI of the first communication module. For example, when a case in which a Bluetooth module fails to transmit an operation state message to a WLAN module is present, the Bluetooth module may set a field value indicating a state of the WLAN module to be “off” in a DSACI of the Bluetooth module.

In an example embodiment, when a communication state or a parameter related to the second communication module is changed, the communication control apparatus may operate as described in the above example in which the communication state or the parameter related to the first communication module is changed.

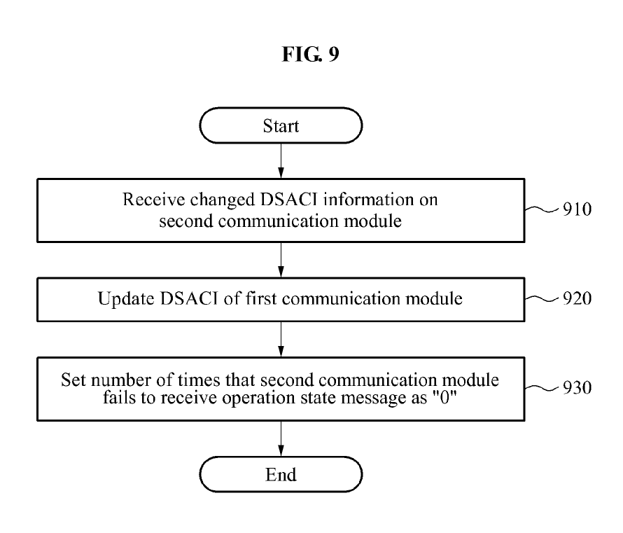

FIG. 9 is a flowchart illustrating an operation performed by a communication control apparatus in response to receiving changed DSACI information on a counterpart communication module according to an example embodiment.

In operation 910, a first communication module receives changed DSACI information on a second communication module.

In operation 920, the first communication module updates a first DSACI by applying the changed DSACI information on the second communication module.

In operation 930, the first communication module sets a number of times that the second communication module fails to receive an operation state message as “0”. The first communication module may update the changed DSACI information on the second communication module. When a change in a communication state or a parameter related to the first communication module is present, a communication control apparatus may operate as described in FIG. 8.

In an example embodiment, the second communication module may receive changed DSACI information on the first communication module and update a second DSACI.

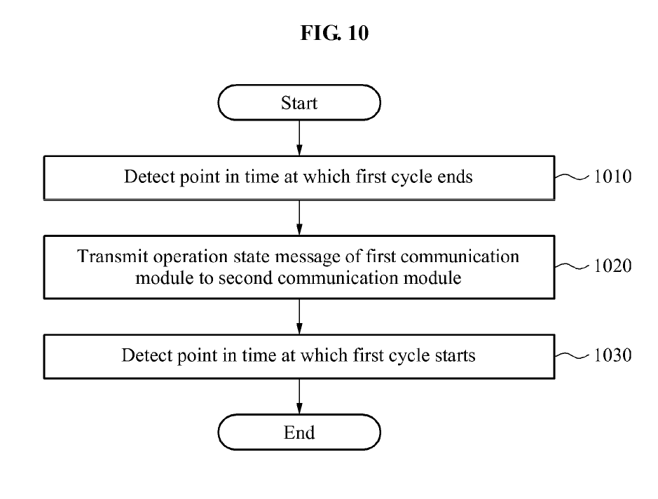

FIG. 10 is a flowchart illustrating an example of transmitting an operation state message of a first communication module to a second communication module at each first cycle according to an example embodiment.

A communication control apparatus may transmit a message indicating an operating state of a communication module to a counterpart communication module at each cycle. In this example, a first cycle may refer to a cycle for transmitting the operation state message of the first communication module to the second communication module. Also, a second cycle may refer to a cycle for transmitting an operation state message of the second communication module to the first communication module.

In operation 1010, a detector detects a point in time at which the first cycle ends.

In operation 1020, a communicator transmits the operation state message of the first communication module to the second communication module.

In operation 1030, the detector detects a point in time at which the first cycle starts. The operation state message may be transmitted to the second communication module to notify that the first communication module is in a proper operation. The operation state message may be used to verify that the communication module being transmitting the operation state message is operating appropriately, and determine a validity of a DSACI stored in the counterpart communication module.

In an example embodiment, the second communication module may transmit an operation state message of the second communication message to the first communication module at each second cycle.

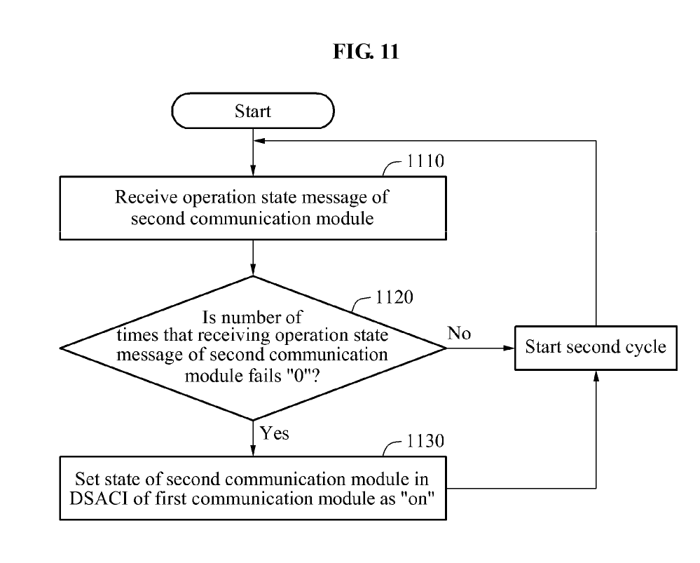

FIG. 11 is a flowchart illustrating an operation performed by a communication control apparatus when an operation state message of a second communication module is received within a second cycle according to an example embodiment.

In operation 1110, a first communication module receives the operation state message of the second communication module.

In operation 1120, the first communication module determines whether a failure in receiving the operation state message is present.

When the failure is present, in operation 1130, the first communication module sets a state of the second communication module in a first DSACI as “on”. In response to the setting, the second cycle for receiving the operation state message of the second communication module may be started. When the failure is absent, the second cycle may be restarted from a point in time at which the first communication module receives the operation state message of the second communication module.

For example, when a WLAN module receives the operation state message, a field value related to a Bluetooth in a DSACI of the WLAN module may be set as “on”. Also, a valid field value may not be changed in the DSACI. The WLAN module may set the second cycle to be started such that an operation state message of the Bluetooth module is received at each second cycle.

In an example embodiment, when an operation state message of the first communication module is received within a first cycle, the communication control apparatus may operate as described in the above example of receiving the operation state message of the second communication module in FIG. 11.

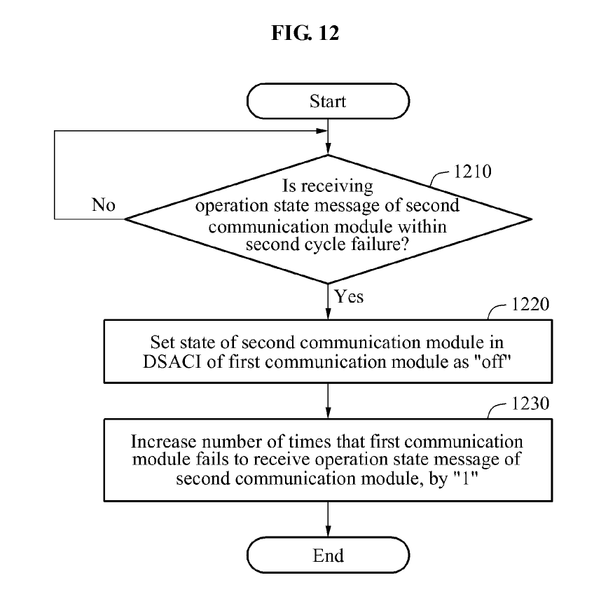

FIG. 12 is a flowchart illustrating an operation performed by a communication control apparatus when an operation state message of a second communication module is not received within a second cycle according to an example embodiment.

In operation 1210, a first communication module verifies whether the operation state message of the second communication module is received within the second cycle

When the operation state message is not received, in operation 1220, the first communication module sets a state of the second communication module in a first DSACI as “off”.

In operation 1230, the first communication module increases, by “1”, a number of times that the first communication module fails to receive the operation state message of the second communication module.

In an example embodiment, when an operation state message of the first communication module is not received within a first cycle, the communication control apparatus may operate based on the above example described in FIG. 12.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner.

The processing device may run an operating system (OS) and one or more software applications that run on the OS. The processing device also may access, store, manipulate, process, and create data in response to execution of the software.

For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A communication control apparatus for controlling data transmission performed by a first communication module and a second communication module, each using a different communication scheme, the apparatus comprising:
a storing unit to store, in a data structure, channel information on a communication module for avoiding communication interference between the first communication module and the second communication module; and
a processor to set, based on the channel information, a channel different from a channel used by the first communication module as a channel of the second communication module,
wherein the first communication module and the second communication module are included in an identical device.

2. The apparatus of claim 1, wherein the channel information comprises at least one of information indicating whether each of the first communication module and the second communication module is using a channel, and information indicating a frequency band used by each of the first communication module and the second communication module.

3. The apparatus of claim 1, wherein when the first communication module fails to receive updated channel information on the second communication module from the second communication module within a predetermined period of time, the processor determines that channel information on the second communication module stored in the data structure is invalid.

4. A communication control apparatus for controlling data transmission performed by a first communication module and a second communication module, each using a different communication scheme, the apparatus comprising:
a detector to detect a change in a parameter related to a field configuring a data structure for avoiding communication interference (DSACI) between the first communication module and the second communication module, or a change in a communication state of each of the first communication module and the second communication module; and
a processor to set a channel in which each of the first communication module and the second communication module avoids communication interference by analyzing the change in the parameter or the change in the communication state,
wherein the first communication module and the second communication module are included in an identical device.

5. The apparatus of claim 4, wherein the communication state corresponds to at least one of primary initiation of the first communication module and the second communication, initiation due to the first communication module and the second communication module being reset, and a change in a frequency band used by each of the first communication module and the second communication module.

6. The apparatus of claim 4, wherein the field configuring the DSACI comprises at least one of a field indicating whether each of the first communication module and the second communication module is using a channel, and a field indicating a frequency band used by each of the first communication module and the second communication module.

7. The apparatus of claim 4, further comprising:
a communicator to transfer a message including the change in the parameter or the change in the communication state, to the DSACI.

8. The apparatus of claim 7, wherein when the message includes the change in the parameter or the change in the communication state of the first communication module, the communicator transfers the message to the second communication module, and
when the message includes the change in the parameter or the change in the communication state of the second communication module, the communicator transfers the message to the first communication module.

9. The apparatus of claim 7, wherein when the first communication module primarily initiates a communication, or when the first communication module initiates the communication due to a reset, the communicator requests information on a DSACI of the second communication module from the second communication module.

10. The apparatus of claim 4, wherein the processor comprises:
a first processor to set a channel for the first communication module from among channels different from a channel used by the second communication module; and
a second processor to set a channel for the second communication module from among channels different from a channel used by the first communication module.

11. The apparatus of claim 7, wherein the communicator transfers information on the communication state or information on the parameter of the first communication module to the second communication module in a first cycle, and transfers information on the communication state or information on the parameter of the second communication module to the first communication module in a second cycle.

12. The apparatus of claim 11, wherein when the first communication module fails to receive the information on the communication state or the information on the parameter of the second communication module in the second cycle, the processor determines that a field of the DSACI relating to the second communication module is invalid.

13. The apparatus of claim 4, wherein the first communication module is a Bluetooth module and the second communication module is a wireless local area network (WLAN) module.

14. A communication control method for controlling data transmission performed by a first communication module and a second communication module, each using a different communication scheme, the method comprising:
storing channel information on a communication module for avoiding communication interference between the first communication module and the second communication module; and
setting, based on the channel information, a channel different from a channel used by the first communication module as a channel of the second communication module,
wherein the first communication module and the second communication module are included in an identical device.

15. The method of claim 14, further comprising:
determining that channel information on the second communication module stored in the data structure is invalid when the first communication module fails to receive updated channel information on the second communication module from the second communication module within a predetermined period of time.
